(19) United States
(12) Patent Application Publication
(10) Pub. No.: US 2006/0244272 A1
(43) Pub. Date: Nov. 2, 2006

(54) Thumbturn connective device for deadbolt lock assemblies

(75) Inventors: Brian K. Roth, Elbert, CO (US); Troy A. Dalsing, Calhan, CO (US)

Correspondence Address: MICHAEL BEST & FRIEDRICH, LLP, 100 E WISCONSIN AVENUE, MILWAUKEE, WI, 53202, US

(73) Assignee: Schlage Lock Company, Carmel, IN (US)

(21) Appl. No.: 11/415,464

(22) Filed: May 1, 2006

Related U.S. Application Data
(60) Provisional application No. 60/676,493, filed on Apr. 29, 2005.

(51) Int. Cl. E05B 3/00

(52) U.S. Cl. 292/336.3

(57) ABSTRACT

A connective device is for a deadbolt lock assembly including a moveable deadbolt, a rotatable spindle connected with the deadbolt, and a handle disposeable about the spindle. The connective device includes a connector, preferably a cylindrical pin, movably coupled with the spindle so as to be linearly displaceable between first and second positions. A biasing member is configured to bias the connector toward the second position. An engagement opening provided within the handle is configured to receive the connector when disposed at the second position so as to couple the handle and the spindle. Preferably, the biasing member includes an arcuate plate disposeable within the spindle, extending circumferentially about an axis and having a carrier portion engageable with the connector. The plate is deflectable to displace the carrier portion in generally radial directions with respect to the axis to move the connector between the first and second positions.

This application claims priority to U.S. Provisional Application Ser. No. 60/676,493, filed Apr. 29, 2005, the entire contents of which are incorporated herein by reference.

### BACKGROUND OF THE INVENTION

The present invention relates to handle assemblies, and more particularly to devices for connecting handles, such as thumbturns, with deadbolt lock assemblies.

Deadbolt lock assemblies typically include a deadbolt moveable between an extended position, at which the bolt engages with a strike to secure a door within a frame, a retracted position, at which the door is displaceable with respect to the frame, one or two cylinder locks operatively connected with the deadbolt, and/or a thumbturn assembly operatively connected with the deadbolt. Such thumbturn assemblies typically include a rotatable spindle connected with the deadbolt, such that rotation of the spindle causes the deadbolt to displace linearly with respect to the door, and a handle connected with, and used to rotate, the spindle. Typically, the handle is connected with the spindle by means of one or threaded fasteners (e.g., screws or bolts). Thus, a tool such as a screwdriver or Allen wrench is generally required to install the handle upon the spindle and for removal therefrom.

### SUMMARY OF THE INVENTION

In one aspect, the present invention is a connective device for a deadbolt lock assembly, the deadbolt lock assembly including a deadbolt, a spindle operatively connected with the deadbolt and a handle disposeable at least partially about the spindle. The connective device comprises a connector movably coupled with either the spindle or the handle so as to be slideably displaceable between first and second positions. The other one of the spindle and the handle provides an engagement opening configured to receive the connector when the connector is disposed at the second position so as to couple the handle and the spindle.

In another aspect, the present invention is again a connective device for a deadbolt lock assembly as discussed above. The connective device comprises a connector movably coupled with the spindle so as to be linearly displaceable between first and second positions. A biasing member is configured to bias the connector toward the second position. Further, an engagement opening is provided within the handle and is configured to receive the connector when the connector is disposed at the second position so as to couple the handle and the spindle.

In a further aspect, the present invention is again a connective device for a deadbolt lock assembly as discussed above, the deadbolt lock assembly including a spindle having a bore and a handle disposeable at least partially about the spindle. The connective device comprises a connector movably coupleable with the spindle and engageable with the handle so as to releasably couple the handle and the spindle. A biasing member includes an arcuate plate disposeable within the spindle bore and configured to bias the connector into engagement with the handle.

In yet another aspect, the present invention is a deadbolt lock assembly comprising a deadbolt and a spindle operatively coupled with the deadbolt and having a bore, an axis extending through the bore, and an opening. A thumbturn has a bore configured to receive at least a portion of the spindle and an opening, the thumbturn opening being alignable with the spindle opening when at least a portion of the spindle is disposed within the thumbturn bore. A connector pin is disposeable within the spindle opening, radially displaceable with respect to the spindle axis between inner and outer positions, and releasably engageable with the thumbturn opening so as to releasably couple the thumbturn and the spindle. Further, an arcuate biasing plate is disposeable within the spindle bore and configured to bias the connector radially outwardly with respect to the spindle axis and into engagement with the thumbturn opening.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an exploded perspective view of a deadbolt lock assembly incorporating a connective device in accordance with the present invention;

FIG. 2 is a broken-away perspective view of the spindle and rose of the deadbolt lock assembly, showing the connective device assembled within the spindle;

FIG. 3 is another broken-away perspective view of the deadbolt lock assembly, shown with the connective device engaged with the handle;

FIG. 4 is an enlarged perspective view of the connective device;

FIG. 5 is an enlarged, axial cross-sectional view of the connective device;

FIG. 6 is an enlarged, axial cross-sectional view of a preferred handle;

FIG. 7 is an axial cross sectional view of the deadbolt lock assembly, shown with the connector in a first position;

FIG. 8 is another axial cross-sectional view of the deadbolt lock assembly, shown with the connective device in a second position and engaged with the handle.

FIG. 9 is a partly exploded view of a deadbolt assembly including the preferred thumbturn connective device of the present invention.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. Further, as used herein, the word “connected” is intended to include direct connections between two members without any other members interposed therebetween and indirect connections between members in which one or more other members are interposed therebetween. Furthermore, the use of the terms “including”, “comprising” and “having” and variations thereof is intended to encompass the items, elements, components, assemblies, etc. listed thereafter and equivalents thereof, as well as additional items, elements, components, assemblies, etc. The terminology includes the words specifically mentioned above, derivatives thereof, and words of similar import.

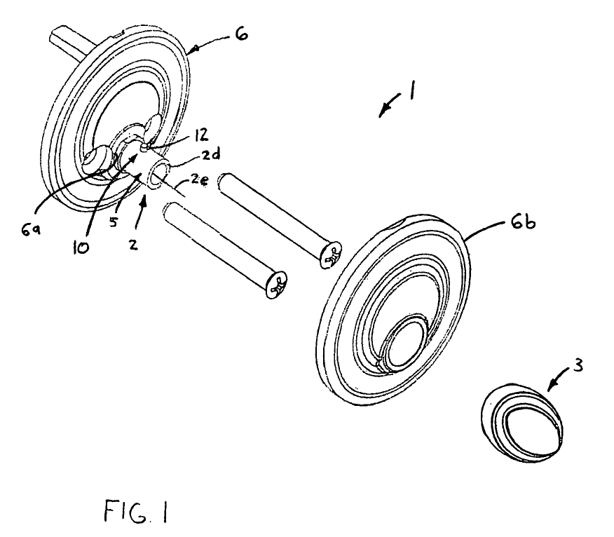

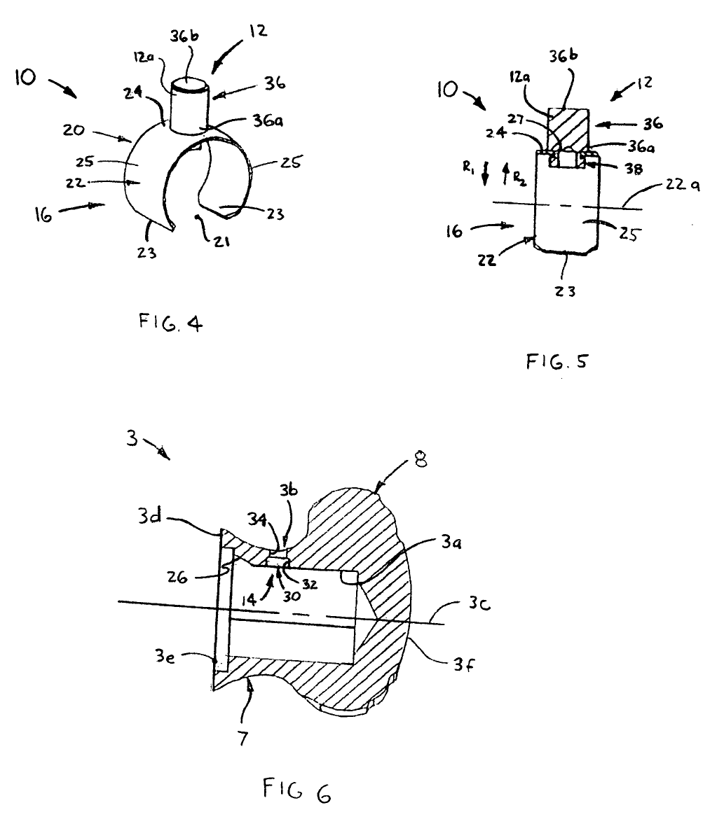

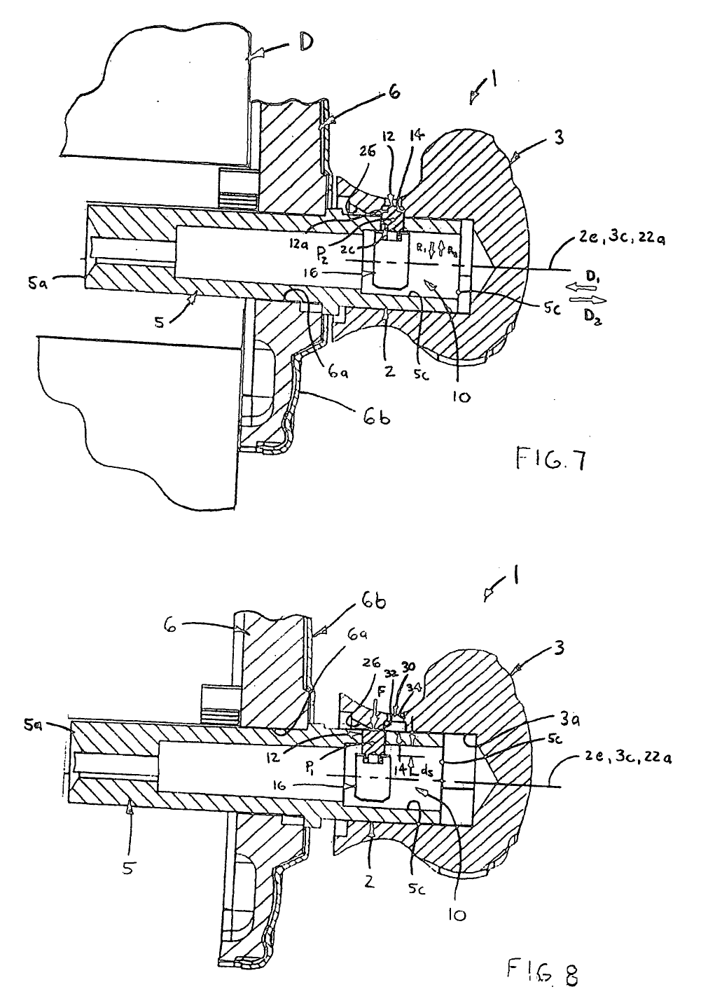

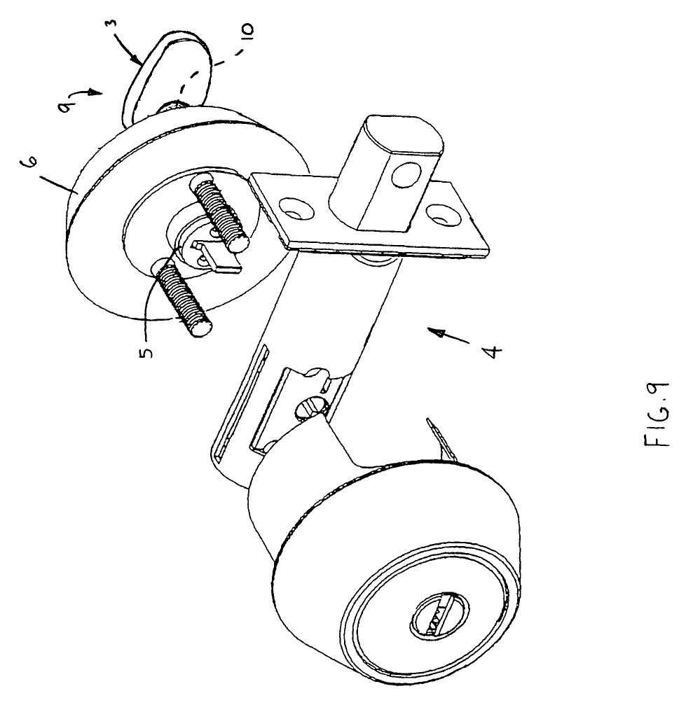

Referring now to the drawings in detail, wherein like numbers are used to indicate like elements throughout, there is shown in FIGS. 1-9 a presently preferred embodiment of a connective device 10 for a deadbolt lock assembly 1, the deadbolt lock assembly 1 including a moveable deadbolt 4 and a thumbturn assembly 9 configured to operate the deadbolt 4, the thumbturn 9 including a rotatable spindle 2 operatively connected with the deadbolt 4 and a handle 3. The spindle 2 has a central bore 2a and a longitudinal axis 2e extending through the bore 2a, and the handle 3 is disposeable at least partially about the spindle 2 and has a central bore 3a configured to receive at least a portion of the spindle 2. The connective device 10 basically comprises a connector 12 and an engagement opening 14 configured to receive the connector 12, and preferably further comprises a biasing member 16. The connector 12 is movably coupled with either the spindle 2 (as preferred) or the handle 3 (structure not depicted) so as to be slideably linearly displaceable (i.e., generally without any rotational movement) between first and second radial positions P₁, P₂, which are spaced by a distance d_{S} (see FIGS. 7 and 8). The engagement opening 14 is provided within the other one of the handle 3 (preferred) and the spindle 2 and is configured to receive at least a portion of the connector 12, when the connector 12 is disposed at the second, outer radial position P₂ (FIG. 7), so as to releasably couple the handle 3 and the spindle 2. Further, the biasing member 16 is configured to bias the connector 12 generally radially outwardly from the spindle axis 2e toward the second, outer radial position P₂. Thus, the connector 12 is generally linearly displaceable from the first, inner radial position P₁ (FIG. 8) toward the second, outer radial position P₂ (FIG. 7) so as to couple the handle 3 and the spindle 2, and is alternatively linearly displaceable from the second position P₂ to/toward the first position P₁ to uncouple the handle 3 and the spindle 3. It must be noted that the two positions P₁ and P₂ are depicted by reference to a point on the connector 12 selected for convenience only and having no particular relevance to the present invention.

As mentioned above, the connector 12 is preferably movably coupled with the spindle 2 and the engagement opening 14 is preferably provided by the handle 3. More specifically, the spindle 2 preferably further has an outer surface 2b and a through-hole 2c extending radially between the bore 2a and the outer surface 2b, and the handle 3 has a recess 3b providing the engagement opening 14 that extends radially outwardly from the handle bore 3a. With this structure, the connector 12 is movably disposeable within the spindle through-hole 2c and has an outer end 12a disposeable within the handle recess 3b to thereby couple the handle 3 with the spindle 2. However, the connector 12 may alternatively be movably coupled with the handle 3 and the engagement opening 14 may alternatively be provided within the spindle 2, with the biasing member 16 being appropriately configured to bias the connector 12 into the engagement opening 14.

Preferably, the biasing member 16 is a “simple beam” flat spring 20 that includes an arcuate plate 22 disposeable within the spindle bore 2b and configured to bias the connector 12 into engagement with the handle 3. The arcuate plate 22 extends circumferentially at least partially about a central axis 22a and has a carrier portion 24 engageable with the connector 12. The arcuate plate 22 further has opposing ends 23, with the carrier portion 24 being preferably disposed centrally between the ends 23, and the carrier portion 24 is preferably connected with the connector 12. However, the carrier portion 24 may alternatively be integrally formed with, or even merely contactable with, the connector 12. Further, the plate 22 is deflectable so as displace the carrier portion 24 in generally radial directions R₁, R₂ with respect to the axis 22a to move the connector 12 generally radially through the distance d_{S} between the first and second positions P₁, P₂, as best shown in FIGS. 8 and 9. Although, the biasing member 16 is preferably provided by the arcuate plate 22, the biasing member 16 may be provided by any other appropriate device, such as for example, a coil spring having a first portion engageable with the connector 12 and a second portion engageable with the spindle 2 (or the handle 3).

Furthermore, the spindle 2 preferably has an outer end portion 2d disposeable within the handle bore 3a. The handle 3 preferably further has a longitudinal central axis 3c, which extends generally collinearly with the spindle axis 2e when the spindle 2 is disposed within the handle bore 3a, a first end 3d with an opening 3e sized to receive the spindle end portion 2d and an opposing second end 3f. The handle 3 is slideable about the spindle 2 along the spindle axis 2e, with the spindle end portion 2e disposed within the handle bore 3a, to align the connector 12 and the engagement opening 14 when the connector 12 is disposed at the first position P₁. Thereafter, the handle 3 is retained at a generally fixed position with respect to the spindle axis 2e when the connector 14 is located at the second position P₂ and disposed within the engagement opening 14.

As best shown in FIG. 6, the handle bore 3a preferably has a ramped surface section 26 extending between the first end 3d and the recess 3b, generally along the handle axis 3c and radially inwardly in a direction from the first end 3d toward the second end 3f. As such, when the handle 3 is displaced along the spindle axis 2e, the ramp surface 26 slides against the connector outer end 12a so as to displace the connector 12 from the second position P₂ and to the first position P₁, thereby enabling the handle 3 to be installed on the spindle 2, as depicted in FIG. 8. Thereafter, the biasing member 16 biases the connector 12 toward the second position P₂, such that the connector outer end 12a becomes disposed within the engagement opening 14. With this structure, the handle 3 is assembled upon the spindle 2 as a “snap-on” process that requires no tools for such assembly. Having described the basic elements of the present invention, these and other components of the present invention are described in further detail below.

Referring first to FIGS. 1-3 and 7-9, the connective device 10 is preferably used with a deadbolt lock assembly 1 for releasably securing a door D within a frame (not shown), as depicted in FIG. 7, but may alternatively used for any other appropriate, generally similar applications. As discussed above, the thumbturn assembly 9 includes the spindle 2 rotatably coupled with the door D, operatively coupled/coupleable with and configured to operate a deadbolt 4 so as to displace the deadbolt 4 between extended and retracted positions with respect to the door D. Preferably, the spindle 2 preferably has a tubular body 5 with an inner end 5a disposed within the door D and an opposing, outer end 5b located externally of the door D. The spindle body inner end 5a is connectable with the deadbolt 4, such as by means of a rectangular bar (not shown), such that rotation of the spindle about the spindle axis 2e causes the deadbolt 4 to displace between the extended and retracted positions as discussed above. Further, the tubular body outer end 5b provides the spindle end portion 2d and is disposeable within the handle bore 3a, as discussed above. Furthermore, the body 5 has a generally circular opening 5c extending into the spindle bore 2c from the outer end 5b, which is sized to receive the connective device 10, as discussed below. Preferably, the deadbolt lock assembly 1 also has a generally circular rose 6 member mountable to the door D and having a central opening 6a sized to receive the inner end 5a of the preferred spindle tubular body 5 and a cover plate 6b.

Preferably, the handle 3 includes a hub portion 7 providing the handle first end 3d and the bore 3a and a hand grip portion 8 configured to be grasped by a user to manipulate the deadbolt lock assembly 1. The handle 3 is preferably a thumbturn or “turn” (also referred to as a “turnpiece”) with an offset grip portion 8, as depicted, but may alternatively be a generally circular knob or any other appropriate type of handle connectable with an deadbolt spindle 2. As best shown in FIG. 6, the handle 3 preferably includes a through-hole 30 with a radially larger counterbore section 32 providing the engagement opening 14. The remaining, radially smaller section of the through-hole 30 provides an access opening 34 for insertion of a disassembly tool (not shown). Such a disassembly tool may be pusher bar (not shown) for displacing or “pushing” the connector 12 from the second position P₂ to the first position P₁, to thereby release or uncouple the handle 3 from the spindle 2 for removal therefrom.

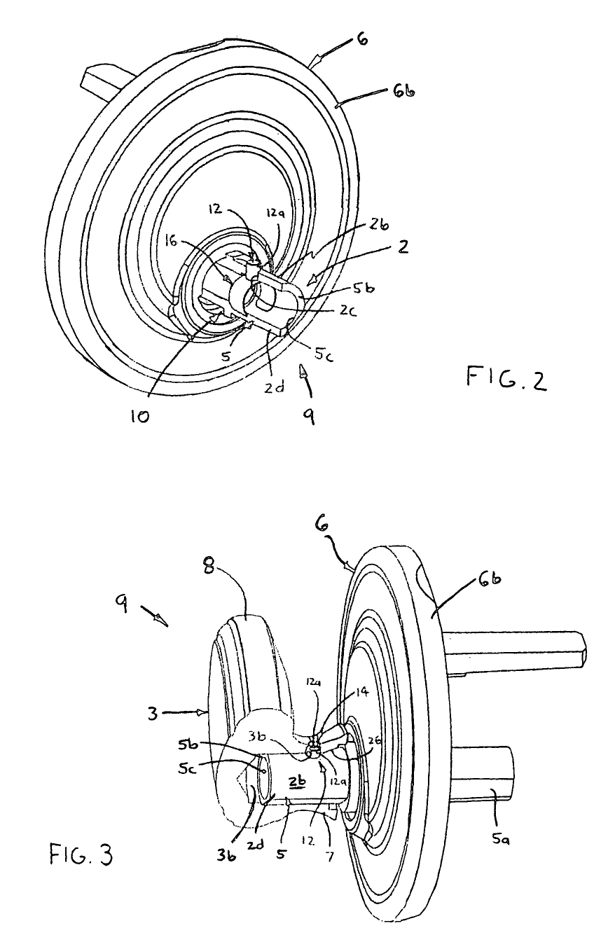

Referring to FIGS. 2-5, 7 and 8, the connector 12 preferably includes a generally circular-cylindrical pin 36 having a first end 36a movably coupled with the spindle 2 (or alternatively with the handle 3) and a second end 36a. The pin second end 36b provides the connector outer end 12a (as discussed above) and is thus disposeable within the engagement opening 14 of the handle 3 (or alternatively the spindle 2). Preferably, the connector pin 36 includes a connective peg or lug 38 extending axially from the first end 36a and disposeable within an opening 27 through the carrier portion 24 of the preferred biasing member 16, as described below. Further, the pin 36 is preferably connected with the preferred biasing member 16 by swaging or otherwise forming the lug 38 so as to retain the lug 38 within the opening 27, but may be retained therein by any other appropriate means, such as by a C-clip, a cotter pin, etc. However, the pin 36 may alternatively be attached to the biasing member 16 by any other appropriate means, such as a threaded fastener or an adhesive, and may even be integrally formed therewith (e.g., formed as a one-piece molded or cast structure). Further, the preferred pin 36 may be separate or unconnected with the biasing member 16, such that the carrier portion 24 is engageable by contact with the preferred connector pin 36.

Although the connector 12 preferably includes a cylindrical pin 36, the connector 12 may be formed with any other appropriate structure that is movably coupleable with the spindle (or handle 3) and slideably linearly displaceable to engage with the engagement opening 14 in the handle 3 (or spindle 2). For example, the connector 12 may be formed as an elongated circular or rectangular bar, as a cross-shaped, star-shaped or polygonal peg, etc., with the spindle through-hole and engagement opening being correspondingly shaped. The scope of the present invention includes these and all other appropriate structures of the connector 12 that enable the connective device 10 to function generally as described herein.

Referring now to FIGS. 2, 4, and 5, as discussed above, the preferred biasing member 16 includes the deflectable arcuate plate 22 having the central carrier portion 24 engaged with the connector 12. The arcuate plate 22 is preferably formed as a relatively thin, partial circular band with a gap 21 and having generally rectangular axial cross-sections. Alternatively, the plate 22 may be formed so as to be generally semi-circular or partially circular with lesser than a semi-circle, with axial cross-sections of any appropriate shape (e.g., ovular, elliptical, etc.), or with any other appropriate arcuate configuration. Further, the arcuate biasing member 22 has a pair of outer portions or legs 25 that each extends between the central carrier portion 24 and a separate one of the outer ends 23. The legs 25 deflect or bend to move the carrier portion 24 in radial directions R₁, R₂ with respect to the central axis 22a, as discussed above and in further detail below.

With the preferred structure, the arcuate plate 22 maintains an arcuate or semi-circular shape when no radial force (i.e., in a direction toward the central axis 22a) is applied to the biasing member 16, so as to thereby retain the connector 12 disposed at the second position P₂. However, when the connector 12 is displaced toward the first position P₁, preferably by interaction with the ramp surface 26 or a disassembly tool (not shown), the connector 12 pushes against the central carrier portion 24 and exerts a force F (FIG. 8) on the arcuate plate 22 such that the plate 22 bends or deflects radially inwardly toward the central axis 22a (i.e., in the first direction R₁). Essentially, the two plate legs 25 each deflect in a manner generally similar to a bending cantilever beam as the central carrier portion 24 displaces in the radially inwardly, such that the connector 12 is displaced to the first, inner position P₁, as best shown in FIG. 8. When the force F is removed (e.g., when the engagement opening 14 aligns with the connector 12, tool is removed from connector 12 or the handle 3 is removed from the spindle 2), material forces in the deflected plate 22 cause the inner ends 25a of the plate legs 25 displace or “snap back” in a radially outward direction R₂ with respect to the central axis 22a, thereby displacing the carrier portion 24 outwardly so as to move the connector 12 to the second position P₂.

Although the above structure is preferred, the biasing member 16 may be formed in any other appropriate manner that functions to bias the connector 12 toward the second position P₂. For example, the biasing member 16 may be provided by an arcuate plate that has a first end connected with the connector 12 and a second end secured to the spindle 2 (or the handle 3), which is bendable generally like a cantilever beam (structure not shown). Further for example, the biasing member 16 may be provided by a coil spring (as discussed above), by a solid by a Belleville spring, or by any other appropriate spring structure. The scope of the present invention includes these and other appropriate structures of the biasing member 16 that enables the connector device 10 to function as described generally herein.

Referring to FIGS. 1, 7 and 8, the preferred connective device 10 is assembled into and utilized with the deadbolt lock assembly 1 as follows. Prior to assembly into the spindle 2, the connector 12 is mounted to the biasing member 16 by inserting the connector lug 38 into the biasing member connective opening 27, and swaging the lug 38 to semi-permanently attach the two components 12, 16. Thereafter, the biasing member 16 partially collapsed by pushing the plate ends 23 together and deflecting the carrier portion 24 radially inwardly so as to move the connector 12 toward the plate central axis 22a, thereby enabling the connective device 10 to fit within the spindle end opening 5c. Once disposed within the spindle opening 5c, the connective device 10 is displaced along the spindle axis 2e until the connector 12 is radially aligned with the spindle through-hole 2c. At which point, the biasing member 16 deflects radially outwardly to displace or “push” the connector 12 through the opening 2c such that the connector 12 is then disposed at the second position P₂.

Thereafter, the handle 3 may be releasably coupled with the spindle 2 by aligning the handle opening 3e with the spindle end portion 2d and then pushing the handle 3 to slidably displace in a first direction D₁ along the spindle axis 2e toward the connective device 10. As such, the spindle end portion 2d becomes increasingly disposed within the handle bore 3. At a certain point along the axis 2e, the handle ramp surface 26 contacts the connector outer end 12a and displaces the connector 12 radially inwardly toward the first position P₁. When the handle engagement opening 14 aligns with the spindle through-hole 2c, the biasing member 16 displaces the connector 12 radially outwardly toward the second position P₂ until the connector outer end 12a becomes disposed within the engagement opening 14. The handle 3 is thereby releasably coupled with the spindle 2, such that the handle 3 may be used to rotate the spindle 2 (and thereby a latch, not shown), or to merely pull upon the spindle 2, to open the associated door D. When it is desired to remove the handle 3 from the spindle 2, a tool (not shown) is used to displace the connector 12 toward the first position P₁, thereby enabling the handle 3 to be slidably displaced in the second direction D₂ along the axis 2e until the spindle end portion 2d is completely withdrawn from the handle bore 3a.

The connective device 10 of the present invention is clearly advantageous over previous devices used to connect handles with spindles. With the connective device 10, a handle 3 may be installed upon a spindle 2 merely by pushing the handle 3 upon the spindle 2 until the connector 12 engages the opening 14, such that assembly of the handle 3 is a “snap on” process. Further, removal of the handle 3 is accomplished merely be momentarily depressing the connector 12, and then pulling the handle 3 from the spindle 2. Clearly, such processes for installing and removing the handle 3 with a deadbolt lock assembly 1 incorporating the present connective device 10 is much quicker and simpler than, for example, rotatably driving a threaded fastener into or out or engagement with a corresponding threaded opening. Further, as the connector 12 always remains coupled with the spindle 2 (or the handle 3), there is no need to locate a fastener during handle installation or to store or dispose of such fastener after removal of the handle 3. Furthermore, the connective device 10 is particularly advantageous for a thumbturn handle 3 of a deadbolt lock assembly 1, which are typically constructed having less axial length and being radially smaller than door handles for operating latches, such that relatively less space is available for installation and removal of the thumbturn 3.

It will be appreciated by those skilled in the art that changes could be made to the embodiments or constructions described above without departing from the broad inventive concept thereof. For example, as discussed above, the biasing member 16 may be a coil spring disposed within either the spindle 2 or the handle 3, the connector 12 may be a pin 36 disposed within the handle 3 and disposeable within an engagement opening within the spindle 2, etc. It is understood, therefore, that this invention is not limited to the particular embodiments or constructions disclosed, but it is intended to cover modifications within the spirit and scope of the present invention as generally described herein and/or as generally defined in the appended claims.

We claim:

1. A connective device for a deadbolt lock assembly, the deadbolt lock assembly including a deadbolt, a spindle operatively connected with the deadbolt, and a handle disposeable at least partially about the spindle, the connective device comprising:
a connector movably coupled with one of the spindle and the handle so as to be slideably displaceable between first and second positions; and
the other one of the spindle and the handle providing an engagement opening configured to receive the connector when the connector is disposed at the second position so as to couple the handle and the spindle.

2. The connective device as recited in claim 1 further comprising a biasing member configured to bias the connector toward the second position.

3. The connective device as recited in claim 2 wherein the biasing member includes an arcuate plate extending circumferentially at least partially about a central axis and having a carrier portion engageable with the connector, the plate being deflectable so as displace the carrier portion in generally radial directions with respect to the axis to move the connector between the first and second positions.

4. The connective device as recited in claim 2 wherein the biasing member is a coil spring having a first portion engageable with the connector and a second portion engageable with the spindle.

5. The connective device as recited in claim 2 wherein the biasing member is one of connected with the connector, contactable with the connector, and integrally formed with the connector.

6. The connective device as recited in claim 1 wherein the connector is displaceable from the first position to the second position to couple the handle and the spindle and the connector is alternatively displaceable from the second position to the first position to uncouple the handle and the spindle.

7. The connective device as recited in claim 1 wherein the spindle has a central bore, an outer surface and a through-hole extending radially between the bore and the outer surface, the connective opening is provided by the handle, and the connector is movably disposeable within the spindle through-hole and has an end disposeable within the handle opening to couple the handle with the spindle.

8. The connective device as recited in claim 1 wherein:
the spindle has an end portion and a central axis and the handle has a bore, the spindle end portion being disposeable within the handle bore;
the handle is slideable along the spindle axis with the spindle disposed within the handle bore to align the connector and the connective opening when the connector is disposed at the first position; and
the handle is retained at a generally fixed position with respect to the spindle axis when the connector is located at the second position and disposed within the connective opening.

9. The connective device as recited in claim 8 wherein:
the handle further has a longitudinal central axis, the handle axis extending generally collinearly with the spindle axis when the spindle is disposed within the handle bore, and a first end with an opening sized to receive the spindle end portion and an opposing second end; and
the handle bore has a ramped surface section extending generally along the handle axis and radially inwardly in a direction from the first end toward the second end such that when the handle is displaced along the spindle axis, the ramp surface slides against the connector so as to displace the connector from the second position and to the first position.

10. The connective device as recited in claim 1 wherein the connector includes a pin having a first end coupled with the one of the handle and the spindle and a second end disposeable within the connective opening of the other one of the handle and the spindle.

11. The connective device as recited in claim 1 wherein the connector is movably coupled with the spindle and the handle includes a through-hole with a counterbore section providing the connective opening, a remainder section of the through bore providing an access opening for insertion of a disassembly tool for displacing the connector from the second position to the first position.

12. The connective device as recited in claim 1 wherein the handle includes a bore with a ramped surface section and a recess providing the connective opening extending radially outwardly from the bore, the spindle has an end portion disposeable within the handle bore and a central axis, the connector is movably coupled with the spindle, the handle being displaceable along the spindle axis such that the ramped surface contacts the connector so that the connector is pushed from the second position and toward the first position until the handle recess aligns with the connector.

13. The connective device as recited in claim 1 wherein the spindle is one of fixedly attached to a door and rotatably coupled with the door and configured to operate a latch.

14. The connective assembly as recited in claim 1 wherein the handle is one of a thumbturn, a knob, and a lever.

15. A connective device for a deadbolt lock assembly, the deadbolt lock assembly including a spindle and a handle disposeable at least partially about the spindle, the connective device comprising:
a connector movably coupled with the spindle so as to be linearly displaceable between first and second positions;
a biasing member configured to bias the connector toward the second position; and
an engagement opening provided within the handle and configured to receive the connector when the connector is disposed at the second position so as to couple the handle and the spindle.

16. The connective device as recited in claim 15 wherein the biasing member includes an arcuate plate extending circumferentially at least partially about a central axis and having a carrier portion engageable with the connector, the plate being deflectable so as displace the carrier portion in generally radial directions with respect to the axis to move the connector between the first and second positions.

17. The connective device as recited in claim 15 wherein the connector is displaceable from the first position to the second position to couple the handle and the spindle and the connector is alternatively displaceable from the second position to the first position to uncouple the handle and the spindle.

18. The connective device as recited in claim 15 wherein the connector includes a pin having a first end coupled with the spindle and a second end disposeable within the handle connective opening.

19. The connective device as recited in claim 15 wherein the handle includes a bore with a ramped surface section and a recess providing the connective opening extending radially outwardly from the bore, the spindle has an end portion disposeable within the handle bore and a central axis, the connector is movably coupled with the spindle, the handle being displaceable along the spindle axis such that the ramped surface contacts the connector so that the connector is pushed from the second position and toward the first position until the handle recess aligns with the connector.

20. The connective device as recited in claim 15 wherein the spindle is one of a rod fixedly attached to a door and a spindle rotatably coupled with the door and configured to operate a latch.

21. A connective device for a deadbolt lock assembly, the deadbolt lock assembly including a spindle having a bore and a handle disposeable at least partially about the spindle, the connective device comprising:
a connector movably coupleable with the spindle and engageable with the handle so as to releasably couple the handle and the spindle; and
a biasing member including an arcuate plate disposeable within the spindle bore and configured to bias the connector into engagement with the handle.

22. The connective device as recited in claim 21 wherein the connector includes a pin having a first end coupled with the arcuate plate and a second end engageable with the handle.

23. The connective device as recited in claim 21 wherein the spindle further has an outer surface and a through-hole extending between the bore and the outer surface, the handle has a connective opening, and the connector is movably disposeable within the spindle through-hole and has an end disposeable within the handle to couple the handle with the spindle.

24. The connective device as recited in claim 21 wherein the connector is displaceable between a first position at which the handle is noncoupled with the handle and a second position at which the handle is coupleable with the spindle, the arcuate biasing member being configured to bias the connector toward the second position.

25. The connective device as recited in claim 24 wherein the handle includes a bore with a ramped surface section and a recess providing a connective opening extending radially outwardly from the bore, the spindle has an end portion disposeable within the handle bore and a central axis, the handle being displaceable along the spindle axis such that the ramped surface section contacts the connector so that the connector is pushed from the second position and toward the first position until the handle recess aligns with the connector.

26. A deadbolt lock assembly comprising:
a deadbolt;
a spindle operatively coupled with the deadbolt and having a bore, an axis extending through the bore, and an opening;
a thumbturn having a bore configured to receive at least a portion of the spindle and an opening, the thumbturn opening being alignable with the spindle opening when at least a portion of the spindle is disposed within the thumbturn bore;
a connector pin disposeable within the spindle opening, radially displaceable with respect to the spindle axis between inner and outer positions, and releasably engageable with the thumbturn opening so as to releasably couple the thumbturn and the spindle; and
an arcuate biasing plate disposed within the spindle bore and configured to bias the connector pin radially outwardly with respect to the spindle axis and into engagement with the thumbturn opening.

27. The deadbolt lock assembly as recited in claim 26 wherein:
the connector pin is slideably displaceable between inner and outer radial positions with respect to the spindle axis;
the thumbturn is slideable about the spindle portion generally along the spindle axis to align the connector and the thumbturn openings, the thumbturn being retained at a generally fixed position with respect to the spindle axis when the connector pin is located at the outer radial position and disposed within the thumbturn opening, the thumbturn further having a longitudinal central axis, the thumbturn axis extending generally collinearly with the spindle axis when the spindle is disposed within the thumbturn bore, a first end with an opening sized to receive the spindle end portion, and an opposing second end; and
the thumbturn bore has a ramped surface extending generally along the thumbturn axis and radially inwardly in a direction from the first end toward the second end such that when the thumbturn is displaced along the spindle axis, the ramp surface slides against the connector pin so as to displace the pin from the outer position and toward the inner position.

28. The deadbolt lock assembly as recited in claim 26 wherein the thumbturn opening includes a through-hole with a radially larger counterbore section configured to receive the connector pin so as to couple the thumbturn with the spindle and a radially smaller section providing an access opening for insertion of a disassembly tool for manually displacing the connector pin from the outer radial postion toward the inner radial postion.
